(19) United States
(12) Patent Application Publication
(10) Pub. No.: US 2013/0094234 A1
(43) Pub. Date: Apr. 18, 2013

(54) LIGHTING DEVICE

(71) Applicant: HELLA KGaA, Lippstadt (DE)

(72) Inventor: Gerhard Kloos, Erwitte (DE)

(73) Assignee: HELLA KGaA, Lippstadt (DE)

(21) Appl. No.: 13/646,201

(22) Filed: Oct. 5, 2012

(30) Foreign Application Priority Data
Oct. 6, 2011 (DE) 102011054232.9

(51) Int. Cl. B60Q 1/00

(52) U.S. Cl. CPC B60Q 1/00
USPC 362/511

(57) ABSTRACT

A lighting device for vehicles with multiple light sources arranged like a matrix in one light generation level, with a light forming optic unit arranged in front of the light sources, and with another optic unit arranged between the light forming optic unit and the light sources, comprising a plurality of optic elements that are arranged like a matrix and one optic element each being allocated at a face thereof to a light source and with the other optic unit in front of the optic elements being allocated to the light sources to coupling areas and at least one decoupling area facing the light forming optic unit, with the other optic unit being embodied as a widening optic unit for widening the partial light bundles emitted by the light sources with light guiding rods as optic elements.

### CROSS REFERENCE

This application claims priority to German Patent Application No. 10 2011 054 232.9, filed Oct. 6, 2011.

### TECHNICAL FIELD OF THE INVENTION

The invention relates to a lighting device for vehicles with a plurality of light sources arranged like a matrix in a light generation level comprising a light forming optic unit arranged in front of the light sources seen in the primary direction of emission and with another optic unit arranged between the light forming optic unit and the light sources, comprising a plurality of optic elements, with the optic element being arranged like a matrix and one optic element each being allocated with its face to a light source and with the other optic unit comprising coupling surfaces in the area of the faces of the optic elements allocated to the light sources and at least one decoupling area facing the light forming optic unit.

### BACKGROUND OF THE INVENTION

Today, increasingly lighting devices are created for vehicles which provide one or more light distributions using a plurality of individual light sources. For example it is known to realize vehicle headlights to implement low beams, high beams, or city lighting functions with a plurality of light diodes. The partial light beams emitted by the individual light diodes here are combined and formed to implement the requested light distributions in at least one light forming optic unit provided in the light path of the light sources according to technical lighting specifications. Here, it is problematic that the plurality of light sources, which may be arranged for example like a matrix, generally fail to show an optimal distance in reference to each other considering technical lighting aspects. If for example pre-assembled arrays are used showing several light sources, here the distance of the light sources arranged on a commonly switched carrier is frequently too low. However, if individual light sources are used, for example individual light diodes in the SMD structure, to create the lighting device, the distance of the individual light sources is frequently greater than it should be for technical lighting aspects.

When LED chips are used as light sources, it is known from DE 10 2008 005 488 A1, for example, to provide another optic element between the light sources arranged on a common lighting level and an optic unit provided in the light path in front of the light sources, particularly a transparent, micro-structured thin plate. Using this plate the partial light beams of the individual light sources are widened. By widening the partial light beams the generation of light spots (light gaps), i.e. sections in the distributed light not or insufficiently lit, is counteracted. For this purpose, the transparent plate comprises a grooved and/or corrugated surface. Although the use of the transparent light source has generally proven to be of value, an individual widening of the individual light beams can only occur to a limited extent for all light sources when a single joint light plate is provided.

For example, it is known from DE 10 2008 013 603 A1, DE 10 2008 044 967 A1, and DE 10 2009 053 581 B3 to provide an optic unit with a plurality of individual optic elements arranged like a matrix. Here, one optic element each is allocated to a single light source such that any partial light beam emitted by an individual light source is essentially formed by an optic element allocated to the light source. The optic array (optic unit) created from the individual light elements serves as an optic unit in a multi-stage light forming arrangement. The individual optic elements show a cross section widening over the beam path, for example in the shape of a frustum and/or truncated pyramid. Accordingly they are expensive in their production. Furthermore, the optic elements to form the light are not or only to a limited extent suitable to widen the partial light beams, due to their design, and to realize a homogenous light emission area.

### SUMMARY OF THE INVENTION

The objective of the present invention is therefore to provide an optic unit to widen the partial light beams of a plurality of light sources, which are easy to produce and yield a homogenous light distribution.

To attain the objective of the invention in the context of the preamble of claim 1 it is characterized that the additional optic unit is embodied as a widening optic unit to widen the partial light beams emitted by the light sources via light guiding rods as the optic elements, with the light guiding rods comprising lateral areas aligned perpendicular in reference to the light generation level of the light sources as total reflection areas.

The particular advantage of the invention comprises that the partial light beams of the individual light sources arranged like a matrix are widened in the optic elements em-bodied as light guiding rods of the widening optic unit and provided at the decoupling area for a largely homogenous light distribution. In the proximity of the decoupling area light spots (light gaps), which due to the distance of the individual light sources are formed when a widening of the partial light beams is waived, are considerably reduced and/or entirely avoided. This is caused in the lateral surfaces of the optic elements allocated to the individual light sources oriented perpendicular in reference to the level of the light generation of the light sources. They act as total reflection surfaces and ensure a homogenous light distribution over the entire cross section of the light guiding elements.

The core of the invention is to provide here a virtual light source by the narrow spatial combination of a plurality of light sources and the widening optic unit comprising a light distribution with high homogeneity at the emission area (decoupling area). With regard to lighting technology the light sources and the allocated widening optic unit form a unit.

According to a preferred embodiment of the invention the light guiding rods show identical cross-sectional geometries. The cross sections are particularly embodied as a polygon, wherein here an area can be covered without overlaps entirely and without any gaps using such polygons. Advantageously the light guiding rods can be placed particularly closely at each other when their cross sections can be briquetted. Here, the light spots (light gaps) are particularly small if no or only very little clear spaces remain between the light guiding rods. For example, the cross sections of the light guiding rods may be embodied triangularly or as even hexagons.

According to a further development of the invention the light guiding rods shows a rectangular, particularly square cross section. The lateral sides of the light guiding rods are aligned in pairs parallel in reference to each other. Advantageously the individual optic elements of the widening optic unit may be placed very closely to each other when a rectangular cross section is used. Additionally, optic elements with a rectangular cross section can be produced easily and cost-effectively.

According to a further development of the invention a common optic disk is allocated to the light guiding rods on a face thereof facing away from the light sources, with the optic disk comprising the decoupling area of the widening optic unit. Advantageously the optic quality and the homogeneity of the light distribution improves by the provision of the joint optic disk covering the individual optic elements at the facial side. Additionally the optic disk provides mechanic stability to the widening optic unit.

According to another further development a lens area is formed in the proximity of the facial side of the optic elements (coupling area) facing the light sources. Advanta-geously the optic effectiveness of the entire arrangement improves by the provision of the lens surface in the proximity of the light coupling area.

According to a further development of the invention the light forming optic unit comprises a lens or a lens arrangement with at least two lenses to form light distribution. The decoupling area of the widening optic unit is provided in the focal level of the lens or the lens arrangement. Advantageously the optic effectiveness of the device is further improved by the arrangement of the decoupling area in the focal level of the light forming optic unit.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 A principle illustration of a lighting device according to the invention in a side view,

FIG. 2 a perspective view of a widening optic unit in a first embodiment,

FIG. 3 a side view of the widening optic unit according to FIG. 2,

FIG. 4 a perspective illustration of a second embodiment of the widening optic unit according to the invention,

FIG. 5 a side view of the widening optic unit according to FIG. 4, and

FIG. 6 a rear view (coupling area) of the widening optic unit in a third embodiment.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

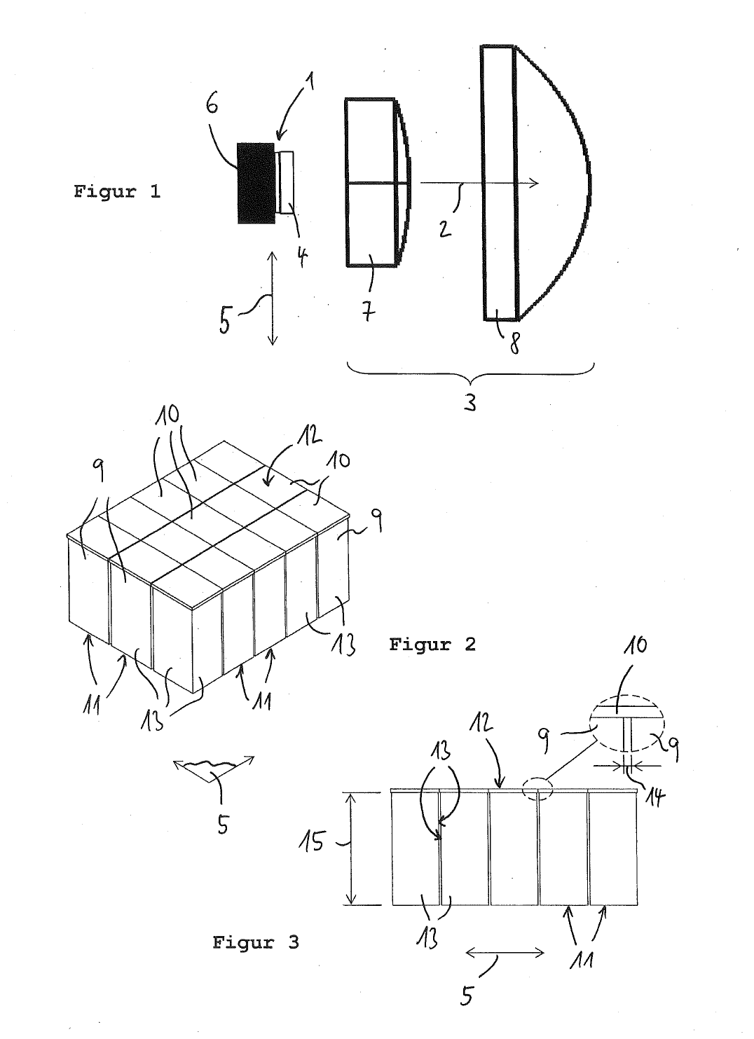

A lighting device according to FIG. 1 comprises a plurality of light sources 1, a light forming optic unit 3 located in front of the light sources 1 in a primary direction of emission 2 of the lighting device, as well as a widening optic unit 4 arranged between the light forming optic unit 3 and the light sources 1. The lighting device serves as the headlights of vehicles, for example. In particular it may be used to form controllable high beams, a dynamic curve light, or other variable light distributions.

The light sources 1 are arranged like a matrix in a light generation level 5. For example, thirty light sources 1 are arranged in three columns. However, eighty or more light sources 1 may be arranged in the light generation level 5. Particularly light diodes may be provided as the light sources 1.

The light sources 1 are preferably provided on a joint interconnected device. In order to discharge heat the light diodes 1 cooperate in a conductive fashion with a cooling body 6. The cooling body 6 may simultaneously operate as the interconnected device.

The light forming optic unit 3 is embodied as a two-lens arrangement, for example. Here, a first lens 7 and a second lens 8 are positioned behind each other in the primary direction of emission 2 of the lighting device. The light forming optic unit 3 serves to form the requested light distribution (high beams, low beams, curve lighting, or the like). Instead of the two-lens arrangement an arrangement comprising only one lens or an arrangement comprising a primary optic (light conductor) and a lens may be provided. Of course, more than two lenses may also be provided to form the light forming optic unit 3.

The widening optic unit 4 may be designed as shown for example in FIGS. 2 and 3 by a plurality of optic elements 9 arranged like a matrix and optic elements 9 with optic disks 10 each arranged therebefore in the primary direction of emission 2. The optic elements 9 are formed as square light guiding rods 9. They show a rectangular cross section and comprise a coupling area 11 facing the facial side of light sources 1, not shown, facing away from the optic disks 10. One optic element 9 each is here allocated with the coupling area 11 to precisely one light source 1. The optic disk 10 is here embodied planar (flat). They directly contact the optic elements 9 and define a decou-pling area 12 facing the light forming optic unit 3.

Lateral areas 13 of the optic elements 9 are aligned perpendicular in reference to the light generation level 5. Two opposed lateral surfaces 13 of the optic elements 9 each are arranged parallel in reference to each other. Adjacent optic elements 9 show a low lateral distance 14 from each other. The lateral distance 14 ranges from 0.06 mm to 0.5 mm. The smaller the lateral distance 14 of the optic elements 9 is, the more ho-mogenous the light distribution in the area of the decoupling area 12. With a decreas-ing lateral distance 14 of the light elements 9, the web-like and/or grid-like light spots (light gaps) caused by the clear space between the optic elements 9 are reduced, oth-erwise recognized as disturbing and interfering with the homogeneity of the light distribution.

The optic elements 9 show an extension 15 of 0.5 mm to 5 mm perpendicular in reference to the light generation level 5 of the light sources 1. An extension 15 of approx. 3 mm is preferred. A low extension 15 allows a particularly compact design of the lighting device. However, the homogeneity of the light distribution improves in the decoupling level 12 with an increasing extension 15 of the optic elements 9. The lateral areas 13 of the optic elements 9 serve here as total reflection areas for the partial light bundles emitted by the light sources 1 and coupled in the optic elements 9.

In order to realize advantageous features of lighting technology the decoupling surface 12 of the winding optic unit 4 is allocated to a focal level of the deformation optic unit 3.

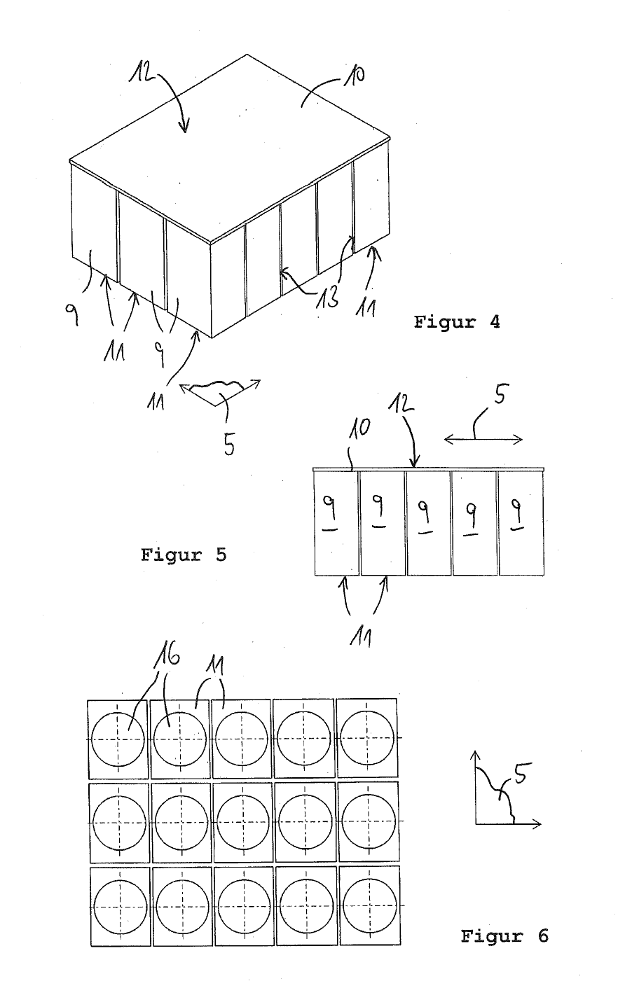

According to a second embodiment of the decoupling optic unit 4 according to FIGS. 4 and 5 a continuous common optic disk 10 is allocated to the cube-shaped optic ele-ments 9. Here, the optic disk 10 also carries the decoupling area 12. By providing a common optic disk 10 the mechanic stability of the widening optic unit 4 improves.

For example, the optic disk 10 as well as the optic elements 9 may be produced from a glass material and connected via an optic adhesive adjusted to the diffraction index. Alternatively the optic elements 9 and the optic disks 10 may be produced from a transparent plastic.

According to a third exemplary embodiment of the invention according to FIG. 6, a lens area 16 is embodied in the area of the coupling area 11 of the optic elements 9. The lens area 16 may be embodied groove-shaped as a recess and/or symmetrically, for example with regard to a geometric center of the face of the optic elements 9. By providing the lens area 16 the optic effectiveness of the arrangement is increased. The partial light beams emitted by the light sources 1 are particularly effectively cou-pled to the, respectively allocated optic elements 9.

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

List of Reference Characters

1 Light Sources

2 Primary Direction of Emission

3 Light Forming Optic Element

4 Widening Optic Unit

5 Light Generation Level

6 Cooling Body

7 Lens

8 Lens

9 Optic Element/Light Guiding Rod

10 Optic Disk

11 Coupling Area

12 Decoupling Area

13 Lateral Area

14 Lateral Distance

15 Extension

16 Lens Area

1. A lighting device for vehicles with a plurality of light sources arranged like a matrix in one light generation level, with a light forming optic unit arranged in front of the light sources seen in the primary direction of emission, and with another optic unit arranged between the light forming optic unit and the light sources, comprising a plurality of optic elements, with the optic elements being arranged like a matrix and one optic element each being allocated comprising coupling areas allocated to the light sources in the area of the faces of the optic elements and at least one decoupling area facing the light forming optic unit, wherein the other optic unit is embodied as a widening optic unit for widening the partial light bundles emitted by the light sources with light guiding rods as optic elements, with the light guiding rods comprising lateral surfaces as total reflection areas aligned perpendicular in reference to the light emitting level of the light sources.

2. The lighting device according to claim 1, wherein the light guiding rods show the same cross-sectional geometry, with the cross-sectional geometry being embodied as a polygon such that a planar area can be covered via the polygons over the entire surface and without any gaps.

3. The lighting device according to claim 1, wherein the light guiding rods show a rectangular cross section with lateral areas arranged in pairs parallel in reference to each other.

4. The lighting device according to claim 1, wherein the light guiding rods are allocated to a common optic disk arranged on the side facing away from the light sources, with the optic disk carrying the decoupling area of the widening optic unit.

5. The lighting device according to claim 1, wherein the optic disk is connected via an optic adhesive to the light guiding rods, adjusted to the diffraction index.

6. The lighting device according to claim 1, wherein the light forming optic unit comprises a lens or a lens arrangement to form a light distribution, with the decoupling area of the widening optic unit being provided in a focal level of the lens or the lens arrangement.

7. The lighting device according to claim 1, wherein a lens area is formed in the area of the coupling area of the light guiding rods.

8. A-The lighting device according to claim 1, wherein the light guiding rods show a constant lateral distance from each other.

9. The lighting device according to claim 1, wherein the lateral distance of adjacent light guiding rods ranges from about 0.06 mm to about 0.5 mm and/or an extension of the optic elements from about 0.5 mm to about 5 mm perpendicular in reference to the light generation level.

10. The lighting device according to claim 1, wherein the light guiding rods and/or the optic disk are formed from a glass material.
